(19) United States
(12) Patent Application Publication
(10) Pub. No.: US 2016/0024702 A1
(43) Pub. Date: Jan. 28, 2016

(54) NON-WOVEN MATERIALS FOR MEDICAL AND BEAUTY END USERS

(71) Applicants: Gerry Paul, Whitelaw, WI (US); Catherine Schuch, Green Bay, WI (US)

(72) Inventors: Gerry Paul, Whitelaw, WI (US); Catherine Schuch, Green Bay, WI (US)

(21) Appl. No.: 14/445,049

(22) Filed: Jul. 28, 2014

(51) Int. Cl. D06C 23/04; B29C 59/04

(52) U.S. Cl. CPC D06C 23/04; B29C 59/04; B29K 2023/12

(57) ABSTRACT

A non-woven material may be created for use in one-time-use or disposable garments, drapes, covers and other items for patient and client care and service. The non-woven material may be made from a non-woven substrate that is embossed to provide a pattern with surface relief so that the embossed non-woven material imitates the feel and texture of a woven material of the same or similar weight per unit area, where the non-woven material may also provide a drapeability that further mimics a woven fabric to be replaced.

### CROSS-REFERENCE TO RELATED APPLICATION

The present application claims priority to earlier-filed U.S. Provisional Applications Ser. Nos. 61/859,165, and 61/859,512, the disclosures of which are incorporated herein by reference in their entirety.

### BACKGROUND

It is common to use non-woven materials for medical uses such as bed and examining table covers and temporary disposable garments for use by care providers and patients. While these materials have many desirable qualities, the feel and texture of such materials have been less than ideal.

It is also common to use traditional woven fabrics for medical uses such as bed sheets and patient garments. While these materials have the desired feel and texture for patient contact, they require laundering after each use.

Improvements to conventional non-woven materials to provide improved texture and feel are desirable.

### DETAILED DESCRIPTION

The present disclosure relates to a non-woven material for use in making temporary or single use garments, bed or examining table coves, treatment surfaces that come into direct patient or client contact, and other similar items. Conventional materials for such applications have either been non-woven materials which provide ease of use and low cost to go with being disposable, or woven materials that have a skin feel and/or texture that is more desirable and/or comfortable to those who come into contact with the materials. The conventional non-woven materials do not provide an adequate skin feel or texture and do not have a pleasing visual appearance. The conventional woven materials do not provide ease of use and disposability.

The non-woven material of the present disclosure is directed to a non-woven material that may provide a high quality skin feel, texture and/or visual appearance that is similar to woven materials while also providing the ease of use, disposability and recyclability of non-woven materials. To further the effect that the non-woven material may have for resembling woven materials, it may be preferable that the non-woven substrate chosen have a similar weight per unit area as the woven material being replaced.

In the context of the present disclosure, it has been determined that polypropylene spunmelt materials may be highly suited for use according to the present application but it is not intended to limit the present application to any one single or group of non-woven materials. It is anticipated that a variety of non-woven materials may be adapted according to the present disclosure to provide the skin feel and texture that is desirable to users.

Items made of the material according the present disclosure have initially targeted to medical uses such as but not limited to use in acute patient care facilities, such as but not limited to emergency rooms, urgent care facilities, outpatient centers, or other facilities where patient turnover might be expected to be higher than in other types of longer term care facilities. It is also intended that these same materials can be used to make client contact materials for use in other health care and beauty settings, such as but not limited to spas, health clubs, laser centers, etc. It is anticipated that the material of the present application may be used for garments or items worn or in contact with both providers and patients/clients.

One of the issues with conventional non-woven or spunmelt materials is that they are perceived as being too paper-like. So much of the perceived quality of an experience can be affected by the feel and texture of the garments and bedding provided to the patient or client. Some of the perception of quality has to do with the condition or appearance of the item as well as the feel of the item. By providing items made of a disposable and recyclable material, the items will ideally never looked like they have been used before and will not be torn or discolored.

Many health care and other client service facilities require that any disposable materials that are used be both recyclable and made from recycled materials. However, many of these types of materials do not provide the desired feel and texture that patients/clients and service providers desire. The present application permits the use of such desirable recycled and recyclable materials while still maintaining the desired feel and texture.

The material of the present application may also be able to provide a higher quality of barrier material that might be provided by conventional woven fabrics. This will permit rooms and facilities to be turned over more quickly between patients/client and permit a greater utilization of facilities, along with advantages provided by the material itself in garment and other patient/client contact items.

The present disclosure relates generally to the use of enhanced embossing patterns and relief heights generated by the embossing to provide the perception of a woven or linen-like material. It has been determined that such embossing can also enhance the opacity of such materials, allowing thinner/lighter materials to be used for particular applications. Providing a lighter material in conjunction with the enhanced feel provided by the embossing can enhance drapeability of the material to further enhance the image and appearance of linen-like quality. Allowing the use of lighter materials can reduce the overall weight of the product and possibly result in fewer injuries at the facilities using items made from the material during handling of bulk quantities.

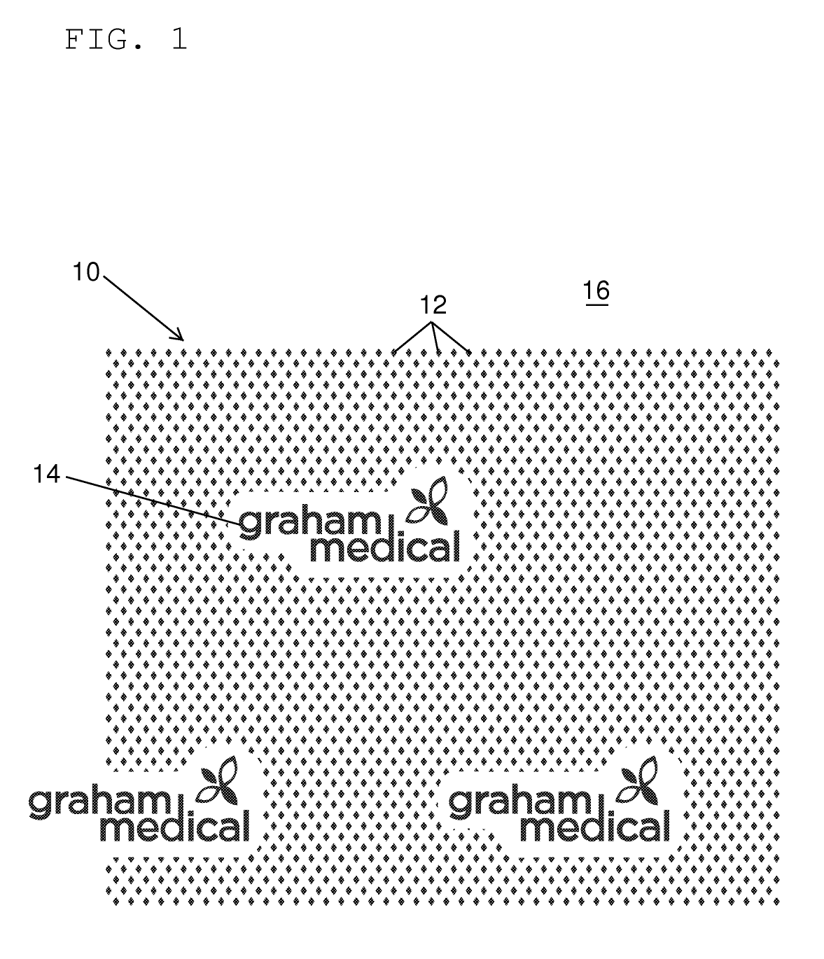

Referring now to FIG. 1, illustrated is a non-limiting example of a male or raised roller pattern 10 that may be used to generate a desired pattern according to the present disclosure in an appropriate substrate. The specifications for the roller pattern shown in FIG. 1 were selected based on the use of a non-woven substrate comprising spunmelt polypropylene having a preferred weight per area of between 25 gsm and 120 gsm. Flat or unembossed nonwoven materials in this range of weight tend to be much stiffer or have a lesser degree of drapability as compared to woven materials of the same or similar weight. Use of an embossing pattern and size as described herein can result in the production of a nonwoven material having a degree of flexibility or drapability that is generally indistinguishable from a similar weight woven material.

These pattern and weight combination options are presented as illustrative only and do not represent an exclusive range of weights or a limited scope of patterns that may be usable within the scope of the present disclosure. It is anticipated that non-woven substrates having weights outside of this range may be used and it is intended that any appropriate pattern for a roller design to emboss the substrate may be used within the scope of the present disclosure.

As shown in FIG. 1, a plurality of smaller elements 12 may be included surrounding a larger pattern 14. Pattern 14 may include but is not intended to be limited to a logo or trademark image, a decorative image, or other words or images that might be desired to be included in the appearance of the embossed material produced with roller pattern 10. Since roller pattern 10 is a male pattern, the raised elements produced by the application of the roller pattern to a substrate will match the raised pattern. To aid in the efficiency and effectiveness of embossing and throughput of an embossing machine utilizing roller pattern 10, the pattern shown may preferably include angled walls so that the top of the embossing element of the roller is larger than the size of the base of the same element, meaning that the elements may be tapered from bottom to top. A preferable angle for such tapering of embossing elements may be approximately twenty degrees, although it is intended that the present disclosure not be limited to such an angle.

In the process of determining a desirable embossing pattern, it has been determined that heating the substrate prior to embossing can enhance not only the initial embossing effectiveness but can also enhance the longevity of the embossing. One possible but non-limiting example of a preheating process for use with the present disclosure may be use of infrared heating immediately prior to the substrate entering the embossing rollers. The durability of the embossing may be further enhanced by allowing the substrate to cool after embossing prior to rolling or packing the embossed material.

As shown in FIG. 1, the height of the embossing elements may be approximately 0.060 inches above a base surface 16 of roller pattern 10. The top side of each of the smaller elements 12 may be preferably 0.055 inches across. Pattern 14 may be selected as needed to provide the visual or image desired for a product made from an embossed substrate created through the use of the roller pattern of the present disclosure. The density or separation of the smaller and larger elements may be preferably selected to provide the feel and texture desired of such a material. While the spacing of smaller elements 12 shown is approximately twice the space between as the size of the embossing element, it is not intended to limit the present disclosure to such a density. Other densities may be chosen based on the overall height of the embossing created by the pattern and the weight of the substrate to be embossed. Further, it is not intended to limit the present disclosure to the same horizontal and vertical spacing between elements, as is illustrated in FIG. 1. Elements may be closer together vertically as opposed to horizontally, or vice versa.

While embossing generally has been found to improve the feel and texture of non-woven substrates, there is on-going research and development to determine the most desirable combination of height and density of embossing pattern along with substrate thickness or per-unit weight for each of a variety of particular implementations and uses of the material according to the present application. It is anticipated that the material may be made directly into the desired end product by to the manufacturer of the embossing material or that the manufacturer may create bulk embossed materials for use by other manufacturers to produce the desired end products.

While the choice of the particular embossing pattern is still under review, it is intended that the present application covers the selection of an embossing pattern relative to the non-woven substrate being embossed so that the resulting embossed material has feel and texture resembling that of a woven material of similar weight. Further, the embossing pattern may be altered for varying weights, densities and/or thicknesses of substrate to provide the desired feel, texture and drape, along with a desired level of opacity to permit effective use of the material to construct garments for one-time wear by users of the products.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A method of creating an embossed non-woven material, the method comprising:
providing a non-woven substrate that is generally flat, the non-woven substrate having a unit weight per area of between 25 gsm and 120 gsm, the substrate being made of recycled materials which are also completely recyclable;
providing a male roller pattern with a plurality of embossing elements extending above a base;
heating the non-woven substrate;
embossing the heated non-woven substrate with the male roller pattern to create an embossed non-woven material with a raised pattern with surface relief in the non-woven material;
wherein the male roller pattern is selected so that the embossed non-woven material has a surface feel and texture resembling a woven fabric of a similar unit weight per area.

2. The method of claim 1, further comprising providing the plurality of embossing elements of the male roller pattern extending approximately 0.060 inches above the base.

3. The method of claim 2, further comprising the plurality of the embossing elements have a taper of approximately twenty degrees from base to top.

4. The method of claim 1, further comprising at some of the plurality of embossing elements of the male roller pattern are similar in size and are spaced apart approximately twice the area of the embossing element.

5. The method of claim 1, further comprising the non-woven substrate is comprised of recycled material and the embossed non-woven material is recyclable.
